(19) United States
(12) Patent Application Publication
(10) Pub. No.: US 2023/0041018 A1
(43) Pub. Date: Feb. 9, 2023

(54) METHOD OF MINERALIZATION OF CO2 IN INORGANIC POLYMERS (GEOPOLYMERS)

(71) Applicant: THE UNIVERSITY OF STAVANGER, Stavanger (NO)

(72) Inventors: Mahmoud KHALIFEH, Hafrsfjord (NO); Helge HODNE, Sandnes (NO)

(73) Assignee: THE UNIVERSITY OF STAVANGER, Stavanger (NO)

(21) Appl. No.: 17/782,359

(22) PCT Filed: Nov. 30, 2020
(86) PCT No.: PCT/EP2020/083835

§ 371 Date: Jun. 3, 2022

(30) Foreign Application Priority Data
Dec. 6, 2019 (SE) 1951409-0

(51) Int. Cl. C04B 28/00; C04B 40/02; C04B 12/00

(52) U.S. Cl. CPC C04B 28/006; C04B 40/0231; C04B 40/0259; C04B 12/005; C04B 40/0263; C04B 2111/00215

(57) ABSTRACT

A process of sequestering CO₂ is generally described. The process involves the use of geopolymeric precursors to which the CO₂ is added. The process for a solid, cementitious material comprising geopolymer(s) and CO₂.

### FIELD OF THE INVENTION

The invention relates to the field of CO₂ utilization, especially to a method of mineralizing CO₂ in a geopolymer-based cementitious material and to a solidified geopolymer-based cementitious material.

### BACKGROUND OF THE INVENTION

Global warming is an international issue, which is mainly related to CO₂ and other greenhouse gas emissions. In 2018, 37.1 billion metric tons of CO₂ was emitted on Earth. CO₂ capturing and storage is a process for capturing CO₂ and sequestrating it, preventing the CO₂ from entering the atmosphere, e.g. from an underground storage.

Portland cement is the most common type of cement; it is a basic ingredient in concrete, mortar, stucco and grout. It is produced by heating limestone and clay minerals. Due to its low cost, it is used globally. Today, Portland cement factories contribute to 5-7% of the total global CO₂ emission.

Geopolymers are inorganic materials forming long-chains of covalently-bonded molecules, for example silicon-oxygen bonds (—Si—O—Si—O-) and/or silicon-oxygen-aluminium bonds (—Si—O—Al—O-). They can be used for example as resins, binders, cements or concretes.

US 2014/0041553 discloses building materials formed from CO₂-sequestering comprising a carbonate/bicarbonate component as well as methods of making and using said building material.

US 2011/0182779 discloses a process for the capture and sequestration of carbon dioxide. CO₂ capture is accomplished by reacting carbon dioxide in flue gas with an alkali metal carbonate, or a metal oxide, to form a carbonate salt. The captured CO₂ is preferably sequestered using any available mineral or industrial waste that contains calcium, magnesium, or iron in non-carbonate forms.

In the prior art, there is a need for an improved method of capturing and storing CO₂ in a cementitious material, and where said material can be used for load-bearing applications. Another need in the area is a process for CO₂ capturing in a material where the CO₂ is stored at least partly via a chemical reaction and wherein the reaction is immediate.

### SUMMARY OF THE INVENTION

The object of the present invention is to provide a method that can mineralize and sequestrate CO₂ in a cementitious material and using said method to form a cementitious product.

In a first aspect, the present invention relates to a method of capturing CO₂ in a geopolymer-based material wherein the method comprises the following steps:
mixing of at least one geopolymeric precursor with a liquid hardener to form a slurry;
adding CO₂ into the slurry to initiate a reaction between the CO₂ and the slurry; and
allowing the slurry comprising the at least one geopolymeric precursor and CO₂ to solidify.

In a second aspect of the invention there is a method of forming a solidified cementitious geopolymer-based material having a permeability of <100 μD.

In a third aspect of the invention there is a use of CO₂ as setting accelerator for a cementitious precursor composition, wherein the cementitious material comprises at least one geopolymeric precursor material.

In a fourth aspect of the invention there is a solidified cementitious geopolymer-based material having a permeability <100 μD.

In the following, the invention will be described in more detail, by way of non-limiting examples and depending claims.

### BRIEF DESCRIPTION OF THE DRAWINGS

FIG. 1 is a flow-chart according to a method of the invention;

FIG. 2 a) shows a picture of a sample according to the process of the invention, b) shows a picture from a comparative example; and

FIG. 3 a) shows a picture of a sample according to the process of the invention, b) shows a picture from a comparative example.

### DEFINITIONS

The following terms are defined:
‘cementitious’: a material that has the functional performance of a cement;
‘geopolymer’: inorganic polymers comprising aluminosilicate;
‘geopolymeric precursor’: solid particles in tetrahedral form which are reactive to participate in geopolymerization;
‘rock-based’: natural rocks which have reactive aluminosilicate components or can be activated through mechanical grinding, calcination or a combination of both;
‘fly-ash based’: amorphous aluminosilicate materials produced when coal is burned;
‘slag-based’: amorphous aluminosilicate materials with CaO and MgO content;
‘D’: darcy, unit for permeability, 1 darcy≈10⁻¹² m²; and
‘Portland cement’: a calcium alumina silicate compound that is manufactured from limestone and clay (or shale) with minor amounts of iron oxide, silica sand and alumina as additives where required to balance the mineral composition.

### DETAILED DESCRIPTION

Geopolymers are a class of inorganic materials, often aluminosilicate materials, that can be used as an alternative to conventional Portland cement. Generally, geopolymers has high mechanical strength, high thermal stability and other properties that are advantageous for a cementitious material. Geopolymers can come from different sources such as fly-ash, rocks and slag etc.

The present invention stores and utilizes CO₂ in a geopolymeric structure by a method wherein CO₂ is mixed with a slurry comprising geopolymeric precursors. In the reaction a solid geopolymeric material that comprises CO₂ is formed. The formed geopolymeric material is similar to a cement. Herein, being similar to a cement implies that the material can be used in load-bearing applications. That is due to high strength and low permeability.

Herein, CO₂ capture and CO₂ sequestration all refer to a process of capturing waste CO₂, and hence preventing it from entering the atmosphere. The CO₂ can for example by captured by geopolymers by a chemical reaction, i.e. a mineralization reaction. In case of a mineralization reaction another material, for example a carbonate such as kalicinite KHCO₃ may be formed. An advantage with mineralization is that the CO₂ is captured in the material via a chemical reaction and hence will not escape during for example destruction of the material.

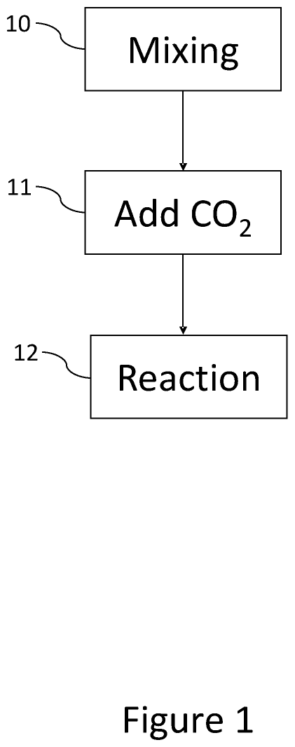

In a first aspect of the invention there is a method comprising the following sequential steps, FIG. 1:
10: mixing of at least one geopolymeric precursor with a liquid hardener to form a slurry;
11: adding CO₂ to the slurry comprising at least one geopolymeric precursor to initiate a reaction between the CO₂ and the slurry; and
12: allowing blend of the geopolymeric slurry and CO₂ to react and solidify.

The geopolymeric precursor material advantageously have a modular ratio, i.e. the ratio of SiO₂/M₂O, that is 2.1-2.4. M stands for metal and can be sodium, potassium, rubidium, or cesium. In the present method if the ratio is too low ratio, such as 1.8 for example the mixture formed in step 10 will set/hardened too fast. On the other hand, in case of a too high ratio, such as 2.5 or above the time for setting will be too long to be of interest for any commercial use. In the method of the present invention the geopolymeric precursor sets after been in contact with the CO₂.

Adding can be performed by injecting the CO₂ into the slurry or any other suitable way.

A geopolymeric precursor is non-cured, in order to form a (cured) geopolymer a hardener must be added to the precursor mixture, e.g. a liquid hardener or a curing agent. Upon the addition of such a component, a reaction is initiated during which the geopolymeric precursors react and form an inorganic polymeric network, hence a geopolymer. In order words, the liquid hardener is used to initiate the reaction between the geopolymeric precursors and CO₂ and participates in the reaction. Examples of liquid hardeners are sodium silicate solution, potassium silicate solution or a combination of both. It is advantageous that the liquid hardener comprises potassium. Potassium will make the system more stable and increase the temperature resistance of the material.

In one example of the first aspect, the mixing in step 10 can be performed using different equipment such as planetary mixers, screw blenders, high shear mixers, etc.

In one example of the first aspect the CO₂ in step 11 is added in a liquid state, in another example of the first aspect, the CO₂ in step 11 is added in gaseous state preferably by injection. The CO₂ can also be in a mixture of both liquid and gaseous state. Once the CO₂ has been added to the geopolymeric slurry, the CO₂ reacts with the slurry comprising geopolymeric precursors and hardener forming a solidified and stable geopolymer-based material. The reaction is rapid, in one example of the method the reaction between CO₂ and the slurry is finished within a few minutes, such as within 2 minutes. In one embodiment the geopolymeric material sets/solidifies immediately, i.e. a flash setting, when CO₂ comes in contact with the geopolymeric precursor and hardener mixture.

Different geopolymeric precursors may be used. In one example of the first aspect, the geopolymeric precursors are fly ash-, slag- or rock-based. It may also be a mixture of different geopolymeric precursors. In one example of the first aspect, the geopolymeric precursors are rock-based. In another example of the first aspect, the geopolymeric precursors are a mixture of rock-based geopolymeric precursors and at least one other geopolymeric precursor.

The geopolymeric precursors in step 10 may have different particle sizes. If the particle size is too large, the geopolymeric precursors may not be reactive and hence there may be no reaction. In one example of the first aspect the average particle size of the geopolymeric precursors is ≤100 μm, preferably ≤63 μm, or more preferably ≤20 μm in average particle size. The geopolymeric precursors are sieved to control the particle sizes. The average particle size can be determined by a particle size distribution of the geopolymeric precursors determined e.g. using a Particle Size Analyzer. Such methods are known to persons skilled in the art.

The different steps of the reaction may be performed at different temperatures. In one example of the first aspect, steps 10-13 are conducted at 0-150° C., preferably 4-100° C., more preferably 4-60° C. In one example of the first aspect, steps 10-13 are conducted at 10-150° C., or 20-50° C. The temperature may be varied between the different steps, i.e. steps 10-13, so that step 11 is performed at one temperature, and step 12 at another temperature, and step 13 at a third temperature. That the reaction can be performed at low or moderate temperature as described above means that the geopolymeric material solidifies, or sets, at such low/moderate temperature. This is advantageous in terms of working temperature, when the geopolymeric material sets at a low or moderate temperature it is easier to handle and to use in different applications.

The different steps of the reaction, i.e. step 10-13, may be performed at different pressures. In one example of the first aspect, steps 10-13 are conducted at 0.1-20 MPa. In another example of the first aspect, steps 10-13 are conducted at 0.1-10 MPa.

The starting pH of the reaction may vary. In one example of the first aspect, the pH may be 12-14. The pH may drop after the reaction has finished, for example to 10-13.

After the reaction, the slurry solidifies to a solid cementitious material of CO₂ and geopolymers. In one example of the first aspect the solid material may comprise or have captured up to 10 wt %, or 2-7 wt %, or 3-5 wt % CO₂, as determined by weight. The CO₂ may be comprised in the material in the form of a carbonate formed by mineralization.

All examples and variations of the first aspect can be combined with the second, third and the fourth aspect.

In a second aspect of the invention, there is a method comprising the steps 10-13 wherein the method is used to form a solid geopolymeric material having a permeability <100 μD. The permeability is a measure of the ability of a material to allow fluids to pass through it, which is related to the connected pores (number of pores, shape of pores, connectivity of the pores) of the material. A high permeability will allow fluids to move more rapidly through the material. It is an advantage with a low permeability, such in the μD range, since such a material will be more resistant to chemicals and minimize internal deterioration when exposed to different fluids. Said material may also act as a barrier material.

All examples and variations of the second aspect can be combined with the first, third and the fourth aspect.

In a third aspect of the invention, CO₂ is used as a setting accelerator for a cementitious precursor composition where the cementitious precursor comprises at least one geopolymer. In such aspect, the CO₂ is injected into a mixture of cementitious precursors to accelerate the setting reaction. It is an advantage with such a use that the cementitious material formed from the reaction comprises and stores CO₂ in the material.

All examples and variations of the third aspect can be combined with the first, second and the fourth aspect.

In a fourth aspect of the invention there is provided a solidified cementitious geopolymer-based material having a permeability <100 μD from a reaction comprising steps 10-13. Such a product can be used in all applications where Portland cement is used today, e.g. as a construction material, or a load bearing element, or a replacement material, or in a mixture with Portland cement.

All examples and variations of the fourth aspect can be combined with the first, second and the third aspect.

### EXPERIMENTS

### Experiment 1

Four different types of geopolymeric slurries were produced to evaluate their reaction with CO₂. Fly ash class F and aplite rock were used as geopolymeric precursors. The hardener was potassium silicate solution. The liquid to solid weight ratio was selected to be 0.52. The different ratios etc. can be seen in table 1.

The hardener was poured into a commercial blender and then the geopolymeric precursor was added to and mixed with the hardener for 15 seconds at 4000 rpm speed, after which the geopolymeric slurry was stirred at 12000 rpm for 35 seconds to obtain a homogenous slurry. After mixing, the slurry was poured into an atmospheric consistometer cup to be conditioned for 20 minutes. The conditioning produces a homogeneous geopolymeric slurry. After conditioning, the geopolymeric slurry was poured into a test cell, with a known weight, and CO₂ was injected into the slurry. The slurry was left until the reaction with CO₂ was complete, the reaction between the geopolymeric slurry and CO₂ was almost immediate. When the setting was completed, the cell was disconnected from the CO₂ source and the pressure lowered to atmospheric condition to remove the non-reacted CO₂, trapped as gas inside the geopolymer matrix. The cell, with the reacted geopolymer, was weighed again to calculate the wt % of captured/reacted CO₂.

TABLE 1
Compositions and corresponding weight of adsorbed CO₂. The temperature
was the same during each method.

| | Geo- | | Type of | | pH | | Weight of | |
|---|---|---|---|---|---|---|---|---|
| | polymeric | | geopoly- | | value | | absorbed | wt. % of |
| Hardener | precursor | Type of | meric | Modular | (start | Temp. | CO₂ | absorbed |
| (g) | (g) | hardener | precursor | ratio* | value) | (° C.) | (g) | CO₂ |
| 66.4 | 127.7 | K-Silicate | Rock- | 2.35 | 13.5 | 50 | 4.52 | 2.3 |
| | | solution | based | | | | | |
| 73.8 | 142 | K-Silicate | Rock- | 2.35 | 13.5 | 22 | 4.59 | 2.1 |
| | | solution | based | | | | | |
| 26.4 | 50.8 | K-Silicate | Fly ash- | 2.3 | 13.5 | 22 | 3.35 | 4.3 |
| | | solution | based | | | | | |
| 30 | 57.2 | K-Silicate | Slag- | 2.4 | 13.5 | 22 | 6 | 6.9 |
| | | solution | based | | | | | |

*Modular ratio means the ratio of SiO₂/M₂O where M can be sodium, potassium, rubidium, or cesium.

### Experiment 2

Two different geopolymer recipes GP1 and GP2 were prepared and exposed for CO₂. The different compositions etc. can be seen in Table 2. As comparison one sample of each recipe (GP1 and GP2) was kept in an isolated cell without exposure to CO₂.

The GP1 samples were cured for 7 days, after which it was exposed to CO₂ in gaseous form. After the CO₂ exposure the sample area exposed to CO₂ solidified/set immediately. The GP1 sample that was not exposed to CO₂ did not solidify/set at all.

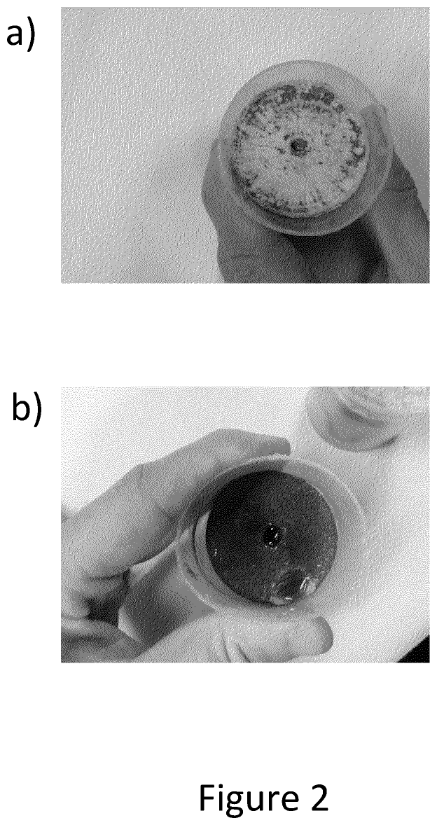

In the next step both GP1 samples, the sample exposed to CO₂ and the one not exposed, were placed in an oven and cured at 70° C. for 4 days. Both samples solidified after the oven treatment. The GP1 sample not exposed to CO₂ shrunk, while the GP1 sample exposed to CO₂ maintained its dimension. The GP1 sample exposed to CO₂ formed kalicinite (KHCO₃) on top and 0.5 cm below the exposure area, as determined by XRD analysis. Pictures of the different GP1 samples can be seen in FIG. 2a and b. FIG. 2a shows a GP1 sample that was exposed to CO₂ and cured as described above, and FIG. 2b shows a GP sample that was not exposed to CO₂ but cured. The kalicinite formed on top of the sample is visible in FIG. 2a.

The GP2 samples were manufactured to solidify at room temperature. Both GP2 samples, the one exposed to CO₂ and the one not exposed to CO₂ solidified at room temperature. However, the GP2 sample exposed for CO₂ was harder at the surface (the CO₂ exposure area) than the non-CO₂ exposed sample.

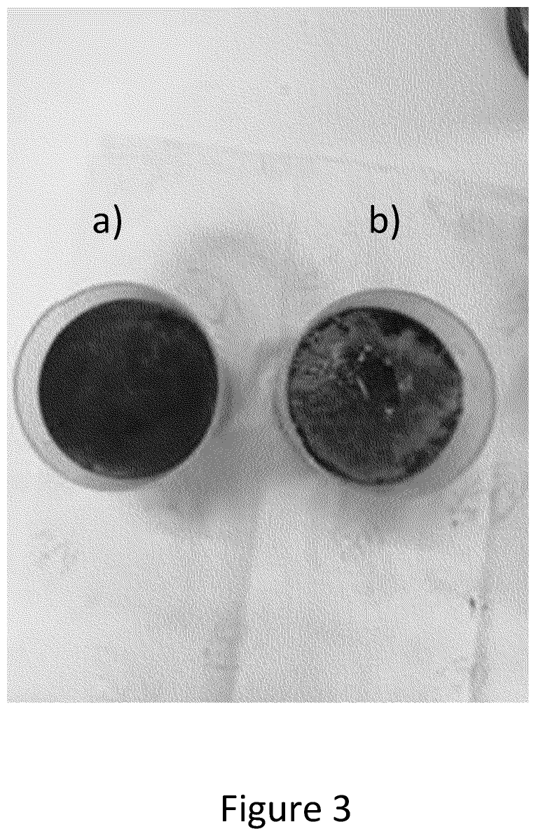

The GP2 sample exposed for CO₂ formed kalicinite at the surface, as determined by XRD analysis. FIG. 3a and b shows the GP2 samples. FIG. 2a shows the GP2 sample that was not exposed to CO₂ while FIG. 2b shows the sample that was exposed to CO₂. In FIG. 2b the kalicinite formed on top of the sample is visible

The GP1 samples exposed for CO₂ had taken up 2.2 wt % CO₂, and the GP2 sample exposed for CO₂ had taken up ˜0.8 wt % CO₂ as determined by weight analysis, before and after exposure.

TABLE 2
Compositions and corresponding weight of adsorbed CO₂. The temperature
was the same during each method.

| | | Geo- | | Type of | | pH | | Weight of | |
|---|---|---|---|---|---|---|---|---|---|
| | | polymeric | | geopoly- | | value | | absorbed | wt. % of |
| | Hardener | precursor | Type of | meric | Modular | (start | Temp. | CO₂ | absorbed |
| | (g) | (g) | hardener | precursor | ratio* | value) | (° C.) | (g) | CO₂ |
| GP1 | 71 | 128 | K-silicate | Rock- | 2.4 | 13.5 | 22 | 4.22 | 2.1 |
| | | | solution | based | | | | | |
| GP2 | 73 | 132 | K-silicate | Rock- | 2.3 | 13.5 | 22 | 1.59 | 0.8 |
| | | | solution | based | | | | | |

*Modular ratio means the ratio of SiO₂/M₂O where M can be sodium, potassium, rubidium, or cesium.

1. A method of capturing CO₂ in a geopolymer-based material wherein the method comprises the following steps:
mixing of at least one geopolymeric precursor with a liquid hardener to form a slurry;
adding CO₂ into the slurry to initiate a reaction between the CO₂ and the slurry; and
allowing the slurry comprising the at least one geopolymeric precursor and CO₂ to solidify,
wherein the ration of SiO₂/M₂O in the geopolymer-based material is 2.1-2.4.

2. The method according to claim 1 wherein the CO₂ is in gaseous state.

3. The method according to claim 1 wherein the CO₂ is in liquid state.

4. The method according to claim 1 wherein the liquid hardener comprises potassium.

5. The method according to claim 1 wherein all the steps are conducted at a temperature of 10-150 ° C.

6. The method according to claim 1 wherein all the steps are conducted at a pressure of 0.1-20 MPa.

7. The method according to claim 1 wherein the pH is 12-14 at the start of the reaction.

8. The method according to claim 1 wherein the geopolymeric precursors are selected from rock-based, fly ash-based and slag-based geopolymeric precursors.

9. The method according to claim 1 wherein the geopolymeric precursors are rock-based.

10. The method according to claim 1 wherein the average particle size of the geopolymeric precursor is ≤100 μm.

11. A method of forming a solidified cementitious geopolymer-based material having a permeability of <100 μD, wherein the method comprises the steps according to claim 1.

12. Use of CO₂ as setting accelerator for a cementitious precursor composition, wherein the cementitious material comprises at least one geopolymeric precursor material.

13. A solidified cementitious geopolymer-based material having a permeability <100 μD.

14. The method according to claim 1 wherein all the steps are conducted at temperature of 20-50° C.

15. The method according to claim 1 wherein all the steps are conducted at a pressure of 0.1-10 MPa.

16. The method according to claim 1 wherein the average particle size of the geopolymeric precursor is ≤63 μm.

17. The method according to claim 1 wherein the average particle size of the geopolymeric precursor is ≤20 μm.
